(19) United States
(12) Patent Application Publication
(10) Pub. No.: US 2014/0242557 A1
(43) Pub. Date: Aug. 28, 2014

(54) AUDIBLE DICTIONARY DEVICE AND METHOD

(71) Applicants: Aderonke Akinsanya, Duluth, GA (US); Sodjidassi Aziadapou, Montgomery, AL (US)

(72) Inventors: Aderonke Akinsanya, Duluth, GA (US); Sodjidassi Aziadapou, Montgomery, AL (US)

(21) Appl. No.: 14/194,046

(22) Filed: Feb. 28, 2014

Related U.S. Application Data
(63) Continuation-in-part of application No. 13/350,392, filed on Jan. 13, 2012, now abandoned.

(51) Int. Cl. G09B 19/06

(52) U.S. Cl. CPC G09B 19/06
USPC 434/156

(57) ABSTRACT

An audible dictionary device defined by a device housing having a multipart screen display, an lock button, a command button, a headphone jack, a keyboard, a speaker, and a detachable stylus. Internally, the audible dictionary device includes a power source, a processor, non-volatile memory, an internal database of reference information. In some embodiments, a network interface which enables the audible dictionary device to receive reference information from a network location is included in addition to or in the alternative of the internal database. The device executes a process by which words are looked up by a user, with the user then being provided with various reference information and be provided audibly in addition to on screen about the looked up word.

### CROSS REFERENCE TO RELATED APPLICATIONS

This application is a continuation in part of, incorporates by reference, and claims the benefit of co-pending U.S. patent application Ser. No. 13/350,392 filed Jan. 13, 2012.

### BACKGROUND OF THE INVENTION

1. Field of the Invention

This invention relates generally to dictionaries and, more particularly, to a method for providing reference information relating to a word verbally.

2. Description of the Prior Art

The use of conventional dictionaries and other reference materials to ascertain the spelling, meaning of, and other information about words is well known. In modern times, such reference materials are often embodied in electronic devices which can receive input on a keyboard or touch screen and display information on a display screen. A problem which still exists, however, is that any existing electronic device reference material implementations typically lack an audible output associated with the visual output. Thus, there remains a need for an audible dictionary device and method which when provided with a word would automatically verbalize desired reference information pertaining to the word. It would be helpful if such an audible dictionary device and method automatically verbalized any words or phrases shown on the device's display screen. It would be additionally desirable for such an audible dictionary device and method to be able to transcribe and process verbal commands from a user.

The Applicant's invention described herein provides for dictionary device and method which provides an oral interface for the provision and receipt of reference information relating to a word or phrase. The primary steps in Applicant's audible dictionary method are receiving a word input, linking the word input, and audibly outputting reference information related to the word input. When in operation, the audible dictionary device and method provides reference information audibly through a streamlined user interaction. As a result, many of the limitations imposed by prior art devices are removed.

### SUMMARY OF THE INVENTION

An audible dictionary device defined by a device housing having a multipart screen display, an lock button, a command button, a headphone jack, a keyboard, a speaker, and a detachable stylus. Internally, the audible dictionary device includes a power source, a processor, non-volatile memory, an internal database of reference information. In some embodiments, a network interface which enables the audible dictionary device to receive reference information from a network location is included in addition to or in the alternative of the internal database. The device executes a process by which words are looked up by a user, with the user then being provided with various reference information and be provided audibly in addition to on screen about the looked up word.

It is an object of this invention to provide an audible dictionary device and method which when provided with a word would automatically verbalize desired reference information pertaining to the word.

It is another object of this invention to provide an audible dictionary device and method which automatically verbalizes any words or phrases shown on the device's display screen.

It is yet another object of this invention to provide an audible dictionary device and method capable of transcribing and processing verbal commands from a user.

These and other objects will be apparent to one of skill in the art.

### BRIEF DESCRIPTION OF THE DRAWINGS

FIG. 1 is a front view of an audible dictionary device built in accordance with an alternate embodiment of the present invention.

FIG. 2 is a front view of an audible dictionary device built in accordance with the preferred embodiment of the present invention.

FIG. 3A shows a partial view of the steps in which the audible dictionary device provides audible reference information to a user in accordance with the present invention.

FIG. 3B shows a partial view of the steps in which the audible dictionary device provides audible reference information to a user in accordance with the present invention.

### DETAILED DESCRIPTION OF THE INVENTION

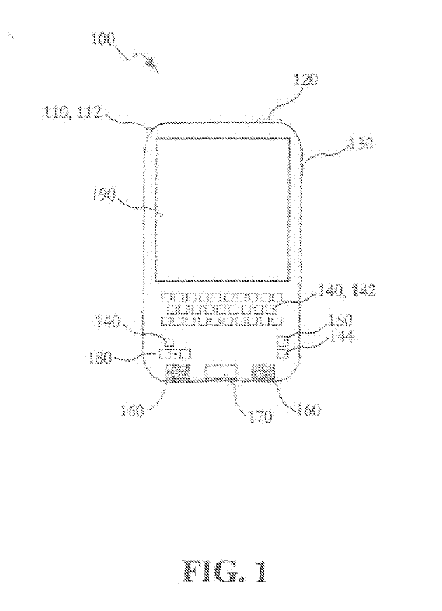

Referring now to the drawings and in particular FIG. 1, an alternate embodiment of an audible dictionary device 100 includes an attached pointer 110, an on and off switch 120, a volume control switch 130, a keyboard 140, a delete button 150, an audio speaker 160, a submit button 170, a language switch button 180 and a screen display 190.

The attached pointer 110 is located inside of a holder (not shown) to use as a touch screen 112 on the audible dictionary device 100. The on and off switch 120 can be any suitable on and off switch such as a toggle switch 122 to turn the audible dictionary device 100 on and off. The volume control switch 130 can be any suitable type of volume control switch and is utilized to control the volume of the audible dictionary device 100. The keyboard 140 is typically a QWERTY keyboard 142 but can be any suitable keyboard type and includes a shift button 144 to control capitalization of letters and other suitable characters disposed on a keyboard 140. The delete button 150 is utilized to delete any previous usage history of words researched or looked-up. The audio speaker 160 emits any sounds that would include words or other suitable verbiage and their one or more meanings that are requested by the user. The submit button 170 is used to submit or enter any word or suitable combination of words that the audible dictionary device 100 would give one or more meanings to. The language switch 180 controls the language that the words entered and their meaning would be emitted and pronounced. The screen display 190 displays the words and their definitions and serves as a touch screen selection surface. The audible dictionary device 100 has a generally rectangular shape, with dimensions of approximately 6 inches long and 4 inches wide. The audible dictionary device 100 is energy efficient, crafted to be solar powered 192 with a back-up rechargeable battery 194.

The audible dictionary device provides a lightweight and portable dictionary that is relatively compact and audible and that also provides a relatively simple glossary. The audible dictionary device 100 is made of plastic but can be made of any suitable material such as metal as well. The audible dictionary device 100 incorporates a relatively easily navigable touch screen with one or more convenient windows to display each word and one or more of its subsequent definition. The audible dictionary device is readily available wherever electronic devices are sold in various colors and designs. The audible dictionary device has the ability of audibly communicating the definition of an unknown entered word. The design of the audible dictionary device not only features a touch screen, but incorporates a key pad for dual functionality and a sleek pointer for use on the touch screen, preventing smudges

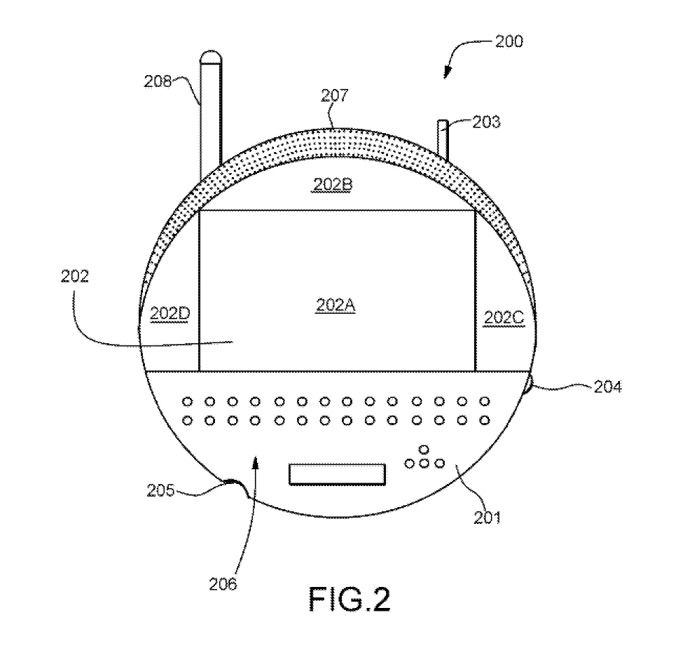

Referring now to FIG. 2, the preferred embodiment of an audible dictionary device 200 is defined by a device housing 201 having a multipart screen display 202, an lock button 203, a command button 204, a headphone jack 205, a keyboard 206, a speaker 207, and a detachable stylus 208. The multipart screen display 202 comprises four discrete screen sections 202a, 202b, 202c, and 202d and provides a visual user interface. The perimeter discrete screen sections 202b, 202c, 202d are defined as touch screens which enable user input via a touch interface. In other embodiments, the central discrete screen section 202a may additionally or alternatively be a touch screen. The lock button 203 is a push button which enables the keyboard 206 and touch screen sections of the multipart screen display 202 to be disabled so that no input is registered while the lock button 203 is engaged. The command button 204 is a push button which actuates the process of providing audible reference information on the audible dictionary device 200. The headphone jack 205 and the speakers 207 provide for audio output from the audible dictionary device 200; either directly through the speakers emitting sounds or indirectly with the headphone jack 205 outputting electrical signals which can be broadcasts as audible sounds by an external speaker. The keyboard 206 provides a manual user input interface by allowing a user to key in letter strings/words as well as request reference information of words. The detachable stylus 208 is stored in a stylus slot (not shown) in the device housing 201, wherefrom it can be removed to be used on the touch screen aspect of the multipart screen display 202.

Internally, the audible dictionary device 200 includes a power source, a processor, non-volatile memory, an internal database of reference information. In some embodiments, a network interface which enables the audible dictionary device 200 to receive reference information from a network location is included in addition to or in the alternative of the internal database. The non-volatile memory includes software containing instructions to cause the processor to perform the steps of the provision of audible reference information process. The database of reference information is defined as a relational database containing base words, each having a plurality of entries associated therewith, such as definitions, Greek roots, number of syllables, common translations, speech classifications, and synonyms and antonyms, as well as exemplary sentences containing word entries and sound files relating to all of the database entries.

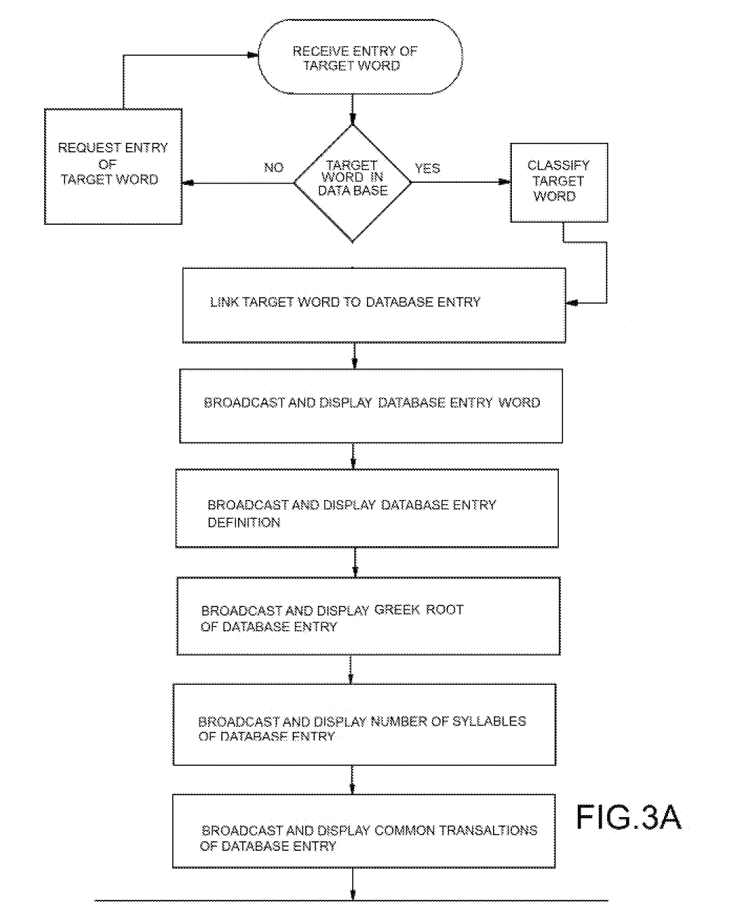

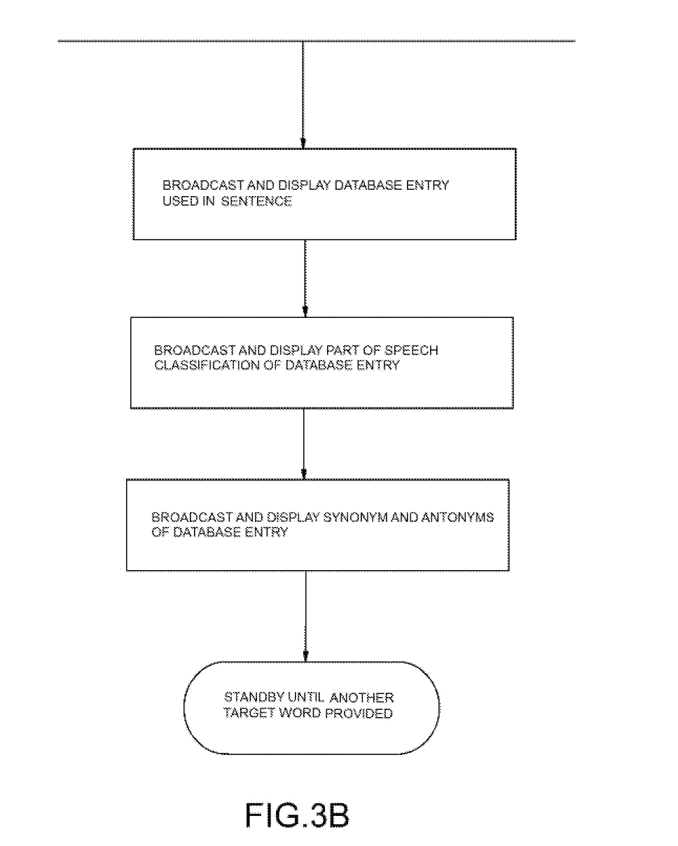

Referring now to FIG. 3, the provision of audible reference information process begins with the receipt of a target word. The target word is a word selected, entered or otherwise provided by a user which is desired to be defined by the audible dictionary device. The target word may be received either through manual entry through the keyboard or touch screen or, in embodiments with a microphone on the audible dictionary device, by receiving and processing by speech recognition software a spoken word. In embodiments with speech recognition, once the word is transcribed by the speech recognition software, the provision of audible reference information process operates the same as words entered by text entry.

Once the target word is received, it is cross referenced with entries in the database of reference information to find a match. If no match is found, another target word is requested and the provision of audible reference information process stands by until another target word is provided. If a match is found, the audible dictionary device then classifies the target word. The database entries are searchable for two categories of target words: base words and common translations. Thus, if the target word received is directly matched with a base word in the database, the all entries for the base word will be linked with the target word. On the other hand, if the target word received is directly matched with a Spanish translation of a base word, the all entries for the base word will be linked with the target word.

Once the database entries for a base word have been linked to the target word, the audible dictionary device begins broadcasting the information in linked database entries audibly and displaying the information in linked database entries visually on a display screen. First, the base word is broadcast and displayed, then the definition of the base word, the Greek root of the base word, the number of syllables, the Spanish and French translations, the base word's use in a sentence, the speech classification (i.e. noun, verb, adjective, etc.), and synonyms and antonyms of the base word. These entries are verbalized at the same time as they are displayed, enabling a user to begin to associate the pronunciation with the sight and use of a word.

It is contemplated that while in the preferred embodiment the languages stored in the common translations are French and Spanish, any language can be substituted/added and indexed so as to remain searchable in the database.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method of providing of audible reference information, comprising the steps of:
providing a device having computer capability, wherein said device includes a processor, non-volatile memory, and a power source;
providing a database of reference information accessible to said processor, wherein the database includes word entries, a definition entry associated to each word entry, and sound files containing verbalized representations of entries in the database;
receiving a target word, wherein said target word is defined by a word for which reference information is sought;
matching by said processor one word entry with the target word;
linking by said processor the matched word entry and the target word; and
causing by said processor the simultaneous audible broadcast and visual display of each entry in the database associated with the linked word entry, wherein the simultaneous audible broadcast and visual display of each entry occurs sequentially when more than one entries are associated with the linked word entry.

2. The method of claim 1, wherein the database additionally includes a Greek root entry associated to each word entry.

3. The method of claim 1, wherein the database additionally includes a number of syllable entry associated to each word entry.

4. The method of claim 1, wherein the database additionally includes a common translation entry associated to each word entry.

5. The method of claim 1, wherein the database additionally includes a use in sentence entry associated to each word entry.

6. The method of claim 1, wherein the database additionally includes a speech classification entry associated to each word entry.

7. The method of claim 1, wherein the database additionally includes a synonym and antonym entry associated to each word entry.

8. A method of providing of audible reference information, comprising the steps of:
providing a device having computer capability, wherein said device includes a processor, non-volatile memory, and a power source;
providing a database of reference information accessible to said processor, wherein the database includes word entries, a definition entry associated to each word entry, a common translation entry associated to each word entry, and sound files containing verbalized representations of entries in the database;
receiving a target word, wherein said target word is defined by a word for which reference information is sought;
matching by said processor the target word with a word entry or a common translation entry;
linking by said processor the target word and the word entry of the matched word entry or common translation entry; and
causing by said processor the simultaneous audible broadcast and visual display of each entry in the database associated with the linked word entry, wherein the simultaneous audible broadcast and visual display of each entry occurs sequentially when more than one entries are associated with the linked word entry.

9. The method of claim 8, wherein the database additionally includes a Greek root entry associated to each word entry.

10. The method of claim 8, wherein the database additionally includes a number of syllable entry associated to each word entry.

11. The method of claim 8, wherein the database additionally includes a use in sentence entry associated to each word entry.

12. The method of claim 8, wherein the database additionally includes a speech classification entry associated to each word entry.

13. The method of claim 8, wherein the database additionally includes a synonym and antonym entry associated to each word entry.

14. A method of providing of audible reference information, comprising the steps of:
providing a device having computer capability, wherein said device includes a processor, non-volatile memory, and a power source;
providing a database of reference information accessible to said processor, wherein the database includes word entries, a definition entry associated to each word entry, a common translation entry associated to each word entry, a Greek root entry associated to each word entry, a number of syllable entry associated to each word entry, a use in sentence entry associated to each word entry, a speech classification entry associated to each word entry, a synonym and antonym entry associated to each word entry, and sound files containing verbalized representations of each entry in the database;
receiving a target word, wherein said target word is defined by a word for which reference information is sought;
matching by said processor the target word with a word entry or a common translation entry;
linking by said processor the target word and the word entry of the matched word entry or common translation entry;
causing by said processor the simultaneous audible broadcast and visual display of the linked word entry;
causing by said processor the simultaneous audible broadcast and visual display of the definition entry associated to the linked word entry;
causing by said processor the simultaneous audible broadcast and visual display of the Greek root entry associated to the linked word entry;
causing by said processor the simultaneous audible broadcast and visual display of the number of syllable entry associated to the linked word entry;
causing by said processor the simultaneous audible broadcast and visual display of the use in sentence entry associated to the linked word entry;
causing by said processor the simultaneous audible broadcast and visual display of the speech classification entry associated to the linked word entry; and
causing by said processor the simultaneous audible broadcast and visual display of the synonym and antonym entry associated to the linked word entry.
